(19) United States
(12) Patent Application Publication
(10) Pub. No.: US 2008/0153345 A1
(43) Pub. Date: Jun. 26, 2008

(54) HOT SWAP FAN

(76) Inventors: Chien-Chang CHEN, Taoyuan Hsien (TW); Cheng-Shu YU, Taoyuan Hsien (TW); Peng-Chu TAO, Taoyuan Hsien (TW)

Correspondence Address: BIRCH STEWART KOLASCH & BIRCH, PO BOX 747, FALLS CHURCH, VA, 22040-0747, US

(21) Appl. No.: 11/963,528

(22) Filed: Dec. 21, 2007

Related U.S. Application Data
(63) Continuation-in-part of application No. 11/797,856, filed on May 8, 2007.

(30) Foreign Application Priority Data
Dec. 22, 2006 (TW) 095148402
Mar. 16, 2007 (TW) 096204249

(51) Int. Cl. H01R 13/00

(52) U.S. Cl. 439/485

(57) ABSTRACT

A hot swap fan includes a fan frame and a terminal seat. A corner of the fan frame has an accommodating space and two connecting parts. The connecting parts are disposed adjacent to the accommodating space. The terminal seat has a seat body and two coupling elements. The coupling elements are disposed at two sides of the seat body and disposed corresponding to the connecting parts, respectively, so that the seat body can be disposed at the accommodating space. The diameters of the connecting parts are larger than those of the coupling elements so that the terminal base can be slightly movable in the accommodating space.

### CROSS REFERENCE TO RELATED APPLICATIONS

The present invention is a continuation-in-part (C.I.P.) application of U.S. patent application Ser. No. 11/797,856, filed on May 8, 2006, which is entitled “Fan, Terminal Seat of Fan, and Method of Forming Terminal Seat”, and claims priority under 35 U.S.C. §119(a) on Patent Application Nos. 095148402 and 096204249 both filed in Taiwan, Republic of China on Dec. 22, 2006 and Mar. 16, 2007, respectively, the entire contents of which are hereby incorporated by reference.

### BACKGROUND OF THE INVENTION

1. Field of Invention

The invention relates to a terminal seat, a fan frame and a method of connecting a terminal to a seat body, and in particular, to a hot swap fan.

2. Related Art

With the enhancements in function and the operation speed of electronic systems, the heat generated by the electronic systems also increases. In order to make electronic systems work normally, the solution in the prior art is to provide a fan serving as a heat-dissipating device to provide an air stream forcing heat dissipation so that the electronic system can be kept at a normal temperature.

As shown in FIG. 1, a conventional fan 11 is connected to a system 14 (e.g., a mainboard or a circuit board) through a set of wires 12 to receive power and a driving signal to operate. The set of wires 12 is connected to the system 14 by way of bonding, or the set of wires 12 is connected to a terminal seat 13 having tubular terminals, and the terminal seat 13 is connected to the system 14. However, when the fan 11 is malfunction, the fan 11 cannot be replaced via the above-mentioned connection while the electronic system is in a state of continuous operation. In order to solve the above-mentioned problem, as shown in FIG. 2, a conventional fan 2, which may be hot swapped, may be directly swapped at the system end. The fan 2 includes a terminal seat 20 assembled on a fan frame 21 of the fan 2. The terminal seat 20 includes a seat body 201 and a plurality of terminals 202 projecting out of terminal holes 203 of the seat body 201. When the terminals 202 are moved radially on the fan 2, the fan 2 can be connected to the system end.

Because the terminals 202 project out in a radial direction, each of the terminals 202 must have a predetermined elasticity in order to enable the terminals 202 to be shifted radially, thereby restricting the thickness and the material of each of the terminals 202. This restriction not only increases the difficulty of inserting the terminals 202 into the terminal holes 203 but also increases the possibility of breaking the terminals 202, thereby reducing the yield in assembling.

### SUMMARY OF THE INVENTION

In view of the foregoing, the invention is to provide a fan, a terminal seat and a method of forming the terminal seat so as to reduce the possibility of breaking the terminals, enhance the connection intensity of the terminal and greatly increase the production and assembly yields.

To achieve the above, the invention discloses a fan including at least one rotor, a housing and at least one terminal seat. The rotor is disposed in the housing. The terminal seat includes a seat body and at least one knife-type terminal. The seat body is disposed on a circumference of the housing and has at least one terminal slot. The knife-type terminal is disposed in the corresponding terminal slot.

To achieve the above, the invention also discloses a fan including at least one rotor, a housing and at least one clamping-type terminal seat. The rotor is disposed in the housing. The clamping-type terminal seat includes a seat body and at least one pin. The seat body is disposed on a circumference of the housing and has at least one terminal slot. The pin is disposed in the corresponding first terminal slot. A contact of the pin extends in a non-radial direction of the fan.

To achieve the above, the invention discloses a knife-type terminal seat including a seat body and at least one knife-type terminal. The seat body has at least one terminal slot. The knife-type terminal is disposed in the corresponding terminal slot.

In addition, the invention discloses a method of forming a knife-type terminal seat. The method includes the steps of providing at least one knife-type terminal and a seat body having a terminal slot, correspondingly disposing the knife-type terminal into the terminal slot, and embedding a fixing portion of the knife-type terminal in the seat body.

To achieve the above, the invention also discloses a method of forming a knife-type terminal seat. The method includes the steps of providing at least one knife-type terminal disposing the knife-type terminal in a mold, and forming a seat body in the mold with the knife-type terminal being embedded into the seat body.

As mentioned above, the terminal is designed as above-mentioned knife-type terminal or clamping-type terminal to enlarge the electrical contact surface area of the terminal, to enhance the intensity of the terminal, to prevent poor contact at the terminal and to provide the predetermined level of fixing force according to the fan, the terminal seat of the fan and the method of forming the terminal seat. Because the working surface of the knife-type terminal of the invention is different from the swapping direction, the thickness of the knife-type terminal is not restricted and the intensity of the knife-type terminal is higher, and the production and assembling yields of the terminal seat can be greatly increased. In addition, because the knife-type terminal of the invention has the plate-like structure, the knife-type terminal may be embedded in the seat body when the seat body of the terminal seat is being shaped. Thus, the connection intensity between the knife-type terminal and the seat body can be greatly increased, and the production yield and the production speed can be greatly increased.

Furthermore, to achieve the above, the invention is to provide a hot swap fan including a fan frame and a terminal seat. A corner of the fan frame has an accommodating space and two connecting parts. The connecting parts are disposed adjacent to the accommodating space. The terminal seat has a seat body and two coupling elements. The coupling elements are disposed on two sides of the seat body and corresponding to the connecting parts, respectively, so that the seat body can be disposed at the accommodating space. The diameters of the connecting parts are larger than those of the coupling elements.

As mentioned above, using the structure of coupling elements and a seat body, the terminal seat of the invention can move in one-dimensional or two-dimensional motion with respect to the fan frame of the hot swap fan. In comparison with the prior art, the hot swap fan adjusts the connection position of the terminal seat to match the connecting terminal of the external system. Therefore, the invention can ensure the precision electrical connection between the hot swap fan and the external system so that the reliability thereof can be increased.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional fan connected to a system;

FIG. 2 is a schematic illustration showing a conventional fan, which may be hot swapped, and a terminal seat thereof;

FIG. 3 is a schematically exploded illustration showing a fan according to a first embodiment of the invention;

FIG. 4 is a schematic illustration showing a knife-type terminal according to the first embodiment of the invention;

FIG. 5 is a flow chart showing a method of forming a terminal seat according to the invention;

FIG. 6 is a flow chart showing another method of forming a terminal seat according to the invention;

FIG. 7A is an exploded view of a hot swap fan according to a second embodiment of the invention;

FIG. 7B is the assembled hot swap fan of FIG. 7A;

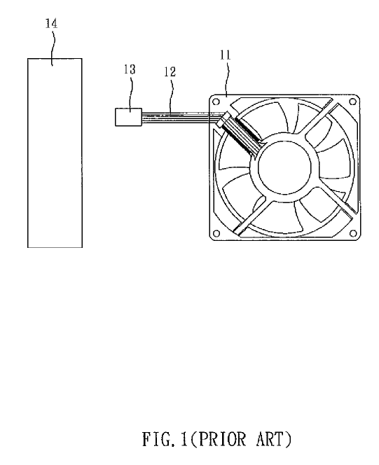

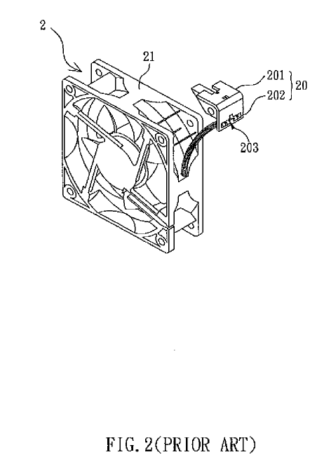

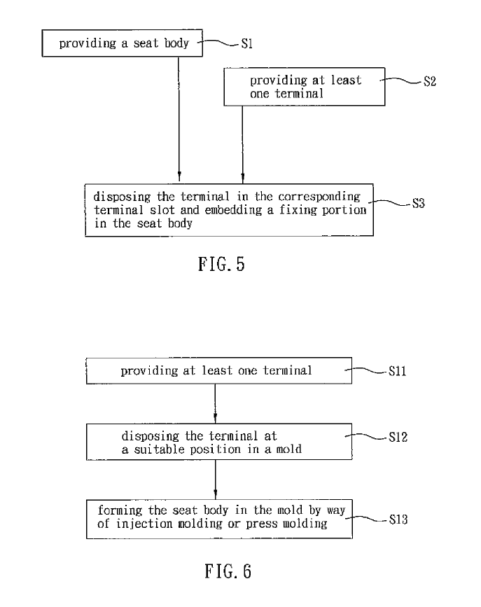

FIG. 5A is an exploded view of a hot swap fan according to a third embodiment of the invention;

FIG. 8B is the assembled hot swap fan of FIG. 8A;

FIG. 9A is a schematic view of the terminal seat according to the third embodiment of the invention;

FIG. 9B is a schematic view showing the status of the buckle and the coupling elements according to the third embodiment of the invention;

FIG. 10 is an exploded view of a hot swap fan according to a fourth embodiment of the invention;

FIG. 11A is a schematic view showing the terminal seat assembled to the hot swap fan according to the fourth embodiment of the invention;

FIG. 11B is an enlarged view of a part of the FIG. 11A; and

FIG. 12 is a schematic view showing the variation of the terminal seat assembled to the hot swap fan shown in FIG. 11A.

### DETAILED DESCRIPTION OF THE INVENTION

The present invention will be apparent from the following detailed description, which proceeds with reference to the accompanying drawings, wherein the same references relate to the same elements.

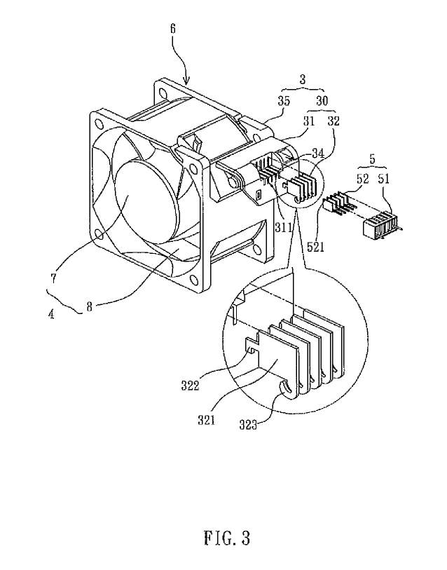

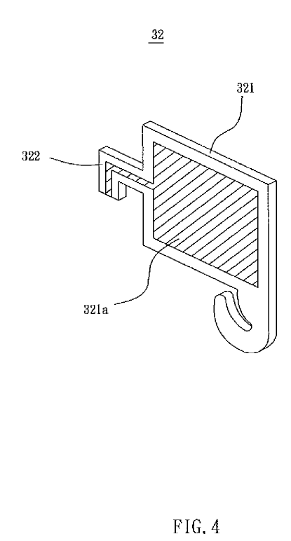

Referring to FIG. 3, a fan 6 according to a preferred embodiment of the invention includes a fan frame 3, a rotor 4 and a control device (not shown). The control device and the rotor 4 are accommodated in the fan frame 3. The control device, such as a driving circuit for the fan 6, controls the rotor 4 to rotate. The fan 6 may be a hot swap fan, for example. The rotor 4 has a hub 8 and at least one blade 7 disposed on a circumference of the hub 8. The blade 7 may be an axial-flow blade, a side-flow blade, a flat blade or a curved blade.

The fan frame 3 includes a frame body 35 and at least one terminal seat 30, which is connected to a circumference of the frame body 35 and is electrically connected to the control device. The terminal seat 30 includes a seat body 31 and at least one knife-type terminal 32.

The seat body 31 is connected to the circumference of the frame body 35 and has at least one terminal slot 311. The seat body 31 may be disposed at a corner of the frame body 35, on a sidewall of the frame body 35, or at any position of the frame body 35. In addition, the seat body 31 and the frame body 35 may be integrally formed as a single piece by injection molding, or may be assembled together. The seat body 31 may be designed to have different shapes according to the shape of the structure of the frame body 35. For example, the cross section of the seat body 31 may be flat, L-shaped or U-shaped. The seat body 31 may be made of the plastic material.

The knife-type terminal 32 is correspondingly disposed in the terminal slot 311. In this embodiment, the knife-type terminal 32 may have a flat structure, a curved structure, a U-shaped structure, an L-shaped structure or any other bent structure. The extending direction of the knife-type terminal 32 preferably conforms to the reaction direction of the terminal seat 30 so that the terminal seat 30 can be swapped with slight or no deformation of the knife-type terminal 32. Thus, the thickness of the knife-type terminal 32 of the invention may be far greater than that of the prior art terminal so as to possess greater intensity. So, when the terminals are assembled on the terminal seat, the terminals cannot be broken, and the production and assembly yields can be greatly enhanced.

In addition, when there are two or more than two knife-type terminals 32, the number of the terminal slots 311 is preferably equal to or greater than that of the knife-type terminals 32. As shown in FIG. 3, the knife-type terminals 32 disposed in the terminal slots 311 may be, without limitation, flush with each other, and the sizes, levels or orientations of the knife-type terminal 32 may be the same or different according to actual requirements.

Referring to FIG. 3, the knife-type terminal 32 has at least one body 321, a signal part 322 and a fixing portion 323. The signal part 322 is connected to the control device. The fixing portion 323 is provided to fix the knife-type terminal 32 in the seat body 31. In this embodiment, the body 321 or the signal part 322 may be electrically connected to the control device through, for example, at least one wire, and the fixing portion 323 may be an inverse hook. When the seat body 31 is being molded, the knife-type terminal 32 may be disposed in a shaping mold of the seat body 31. Therefore, the seat body 31 embeds at least the fixing portion 323, and the knife-type terminal 32 is fixed in the terminal slot 311. Alternately, the knife-type terminal 32 may also be inserted into the terminal slot 311 after the seat body 31 is molded, and then fixed in the terminal slot 311 via the fixing portion 323.

The body 321 is to be electrically connected to a clamping-type terminal seat 5 to receive signals transferred between the fan 6 and the clamping-type terminal seat 5. The signals may be, for example, a power signal, a driving signal, a warning signal, a state signal or the like. The body 321 is clamped by and electrically connected to the clamping-type terminal seat 5. The body 321 may have a flat structure, a curved structure, a U-shaped structure, an L-shaped structure or any other bent structure, for example.

As shown in FIGS. 3 and 4, the body 321 and the signal part 322 may be made of a conductive material or a non-conductive material, such as a plastic material. When the body 321 or the signal part 322 is made of the non-conductive material, at least one side surface (e.g., plate-like surface) of the body 321 or the signal part 322 is formed with at least one conductive film 321a, which is electrically connected to the signal part 322 or the body 321 composed of the conductive material. The conductive film 321a may be partially embedded in the body 321 or the signal part 322, and may be only formed on the surface of the body 321 or the signal part 322. When the body 321 and the signal part 322 are made of non-conductive material, the conductive film 321a forms one conductive path, two conductive paths or more than two conductive paths on the body 321 and the signal part 322 simultaneously.

In addition, when there are two or more conductive films 321a, the conductive films may be formed only on the same surface of the body 321 or the signal part 322, on opposite surfaces of the body 321 or the signal part 322, or partially on the same surface and partially on the opposite surfaces.

In addition, the clamping-type terminal seat 5 corresponds to the seat body 31 and has at least one pin 52 and a seat body 51. The pin 52, which is accommodated in the seat body 51 and disposed corresponding to the body 321, is electrically connected to the body 321. The pin 52 may have, for example, an elastic structure, a bent structure or a structure with a protruding structure 521, wherein the protruding structure 521 preferably extends toward the inner wall or extends along a direction forming an angle relative to an extending surface of the pin 52. The body 321 or the conductive film 321a may be clamped by the pin 52 and the inner wall of the seat body 51 or clamped by multiple pins 52. Alternatively, the signal transmission amount can be increased by adjusting the number of pins 52 corresponding to the conductive films 321a so that the number of terminals can be greatly reduced, and the volume of the terminal seat can be reduced.

The clamping-type terminal seat 5 may be disposed on an external system housing, an interface card, a mainboard, a circuit board or any other external system. In addition, the embodiment is described according to the preferred but non-limitative example, in which the terminal seat 30 is disposed on the frame body 35, and the clamping-type terminal seat 5 is not disposed on the frame body 35. Instead, the clamping-type terminal seat 5 may be disposed on the frame body 35 but the terminal seat 30 is not disposed on the frame body 35. The contact at the middle section or the front end of the pin 52 of the clamping-type terminal seat 5 extends in a non-radial direction of the fan 6 or in a direction different from the extending direction of the knife-type terminal 32. Combining the knife-type terminal 32 of the terminal seat 30 with the clamping-type terminal seat 5 enables the fan 6 to be fixed to the external system with a predetermined level of fixing force without any other fixing structure.

In addition, the frame body 35 or the seat body 31 of the fan 6 may further have at least one hole 34 for accommodating a display (not shown), which may be a light emitting diode (LED), a laser diode (LD), an organic electroluminescent device (OELD) or a field emission device (FED). The hole 34 may be disposed at any position of the frame body 35 or on the seat body 31.

As shown in FIGS. 3 and 5, the method of forming the terminal seat of the invention includes the following steps. Step S1 provides a seat body 31 having at least one terminal slot 311. Step S2 provides at least one knife-type terminal 32. Step S3 disposes the knife-type terminal 32 in the corresponding terminal slot 311 and embeds the fixing portion 323 in the seat body 31.

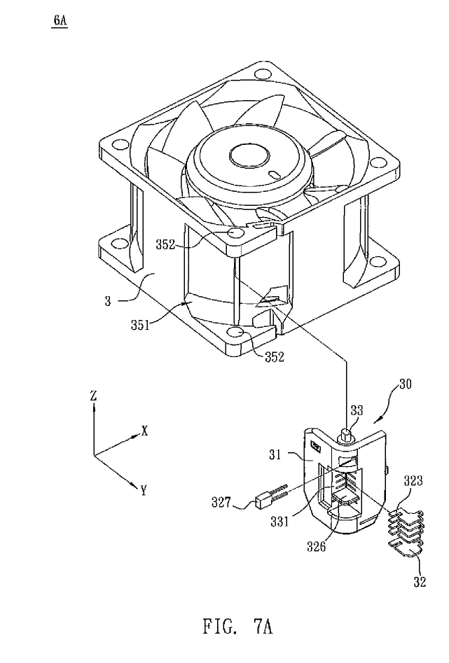

In addition, as shown in FIGS. 3 and 6, the terminal seat of the invention may also be formed by the following steps. Step S11 provides at least one knife-type terminal 32. Step S12 disposes the knife-type terminal 32 at a suitable position in a mold. Step S13 forms the seat body 31 in the mold by way of injection molding or press molding. At this moment, the knife-type terminal 32 may also be fixed in the terminal slot 311 of the seat body 31.

Alternatively, when the terminal seat 30 of fan 6 of the invention is modified into the clamping-type terminal seat 5, the clamping-type terminal seat may be easily formed by this method by replacing the knife-type terminal 32 with the pin 52. When the seat body 31 or 51 is being formed, the seat body 31 or 51 and the frame body 35 may be integrally formed, or the seat body 31 or 51 may be formed and then combined with the frame body 35. The seat body may be made of a plastic material.

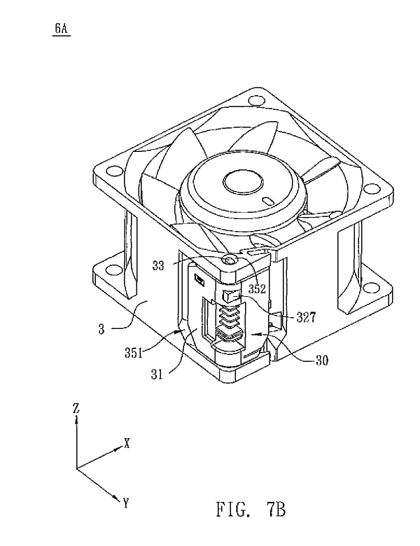

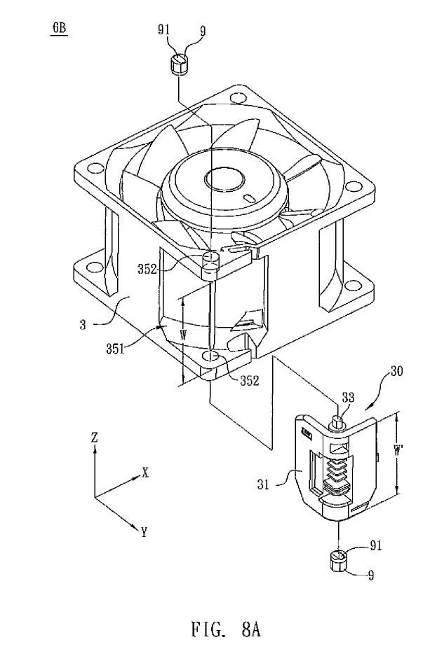

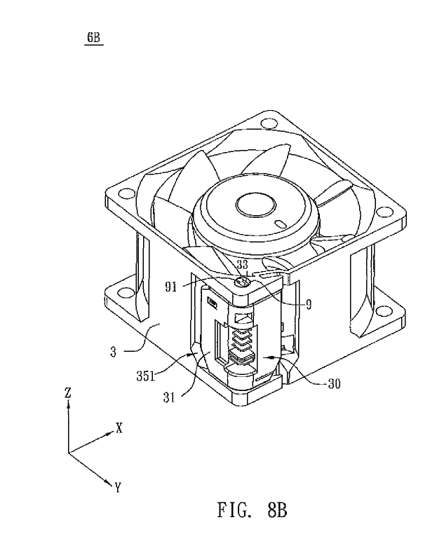

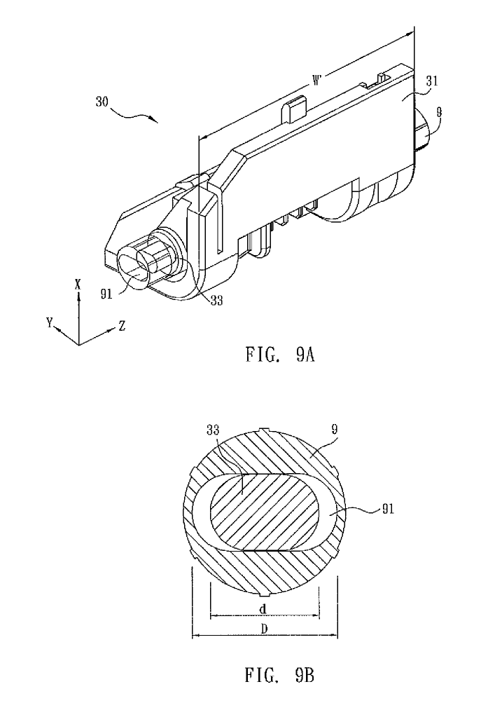

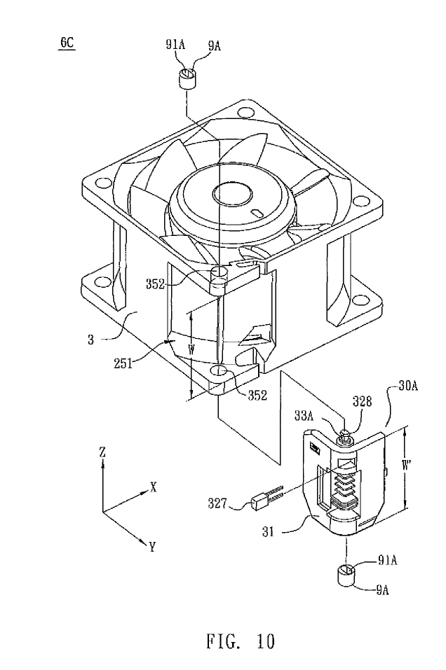

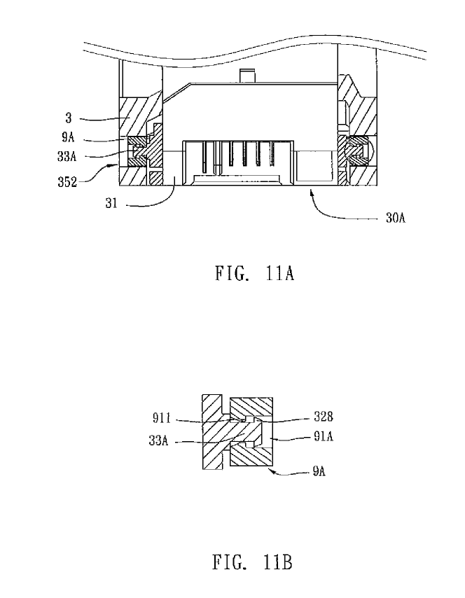

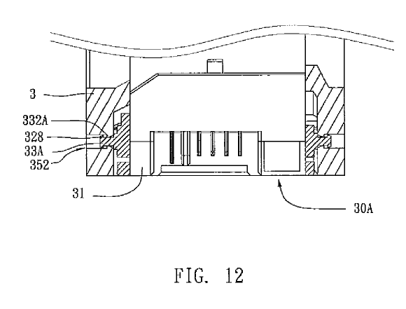

With reference to FIG. 7A, the hot swap fan 6A according to a second embodiment of the invention includes a fan frame 3 and a terminal seat 30. The hot swap fan 6A can be an axial-flow fan. A corner of the fan frame 3 has an accommodating space 351 and two connecting parts 352. The connecting parts 352 are disposed adjacent to the accommodating space 351. In this embodiment, the connecting parts 352 are disposed on two opposite sides of the accommodating space 351. But the invention is not limited to this example.

The terminal seat 30 has a seat body 31 and two coupling elements 33. The coupling elements 33 are disposed on both sides of the seat body 31. In this embodiment, the coupling elements 33 are disposed on two opposite sides of the seat body 31 and corresponding to the connecting parts 352. The cross section of the seat body 31 has an L shape. The coupling elements 33 are disposed on both sides of the turning point of the seat body 31, and can be integrally formed with the seat body 31 as a single unit. The shape of the coupling elements 33 can be an elliptical, circular, square or polygonal.

It should be noted that the connecting parts 352 of the fan frame 3 and the coupling elements 33 of the terminal seat 30 can be disposed in a symmetric or asymmetric way. That is, they can be disposed symmetrically or asymmetrically on both sides. The diameter of the connecting parts 352 is larger than that of the coupling elements 33 so that the coupling elements 33 can move in one-dimensional or two-dimensional motion relative to the connecting parts 352. The precision and reliability of the electrical connection between the hot swap fan 6A and the external system can be enhanced.

The terminal seat 30 has several terminals 32 and a terminal slot 331. The terminals 32 are electrically connected with a motor (not shown) of the hot swap fan 6A and with the external system so that the motor is driven by the driving signal of the external system. The terminals 32 are knife-type terminals that are made of a conductive material or coated with a conductive material by electroplating on the surface thereof. Besides, each of the terminals 32 has a fixing portion 323 in a hook-like shape and disposed in the terminal 331. The seat body 31 has a positioning element 326 made by non-conductive material and integrally formed with the seat body 31 as a single unit. The positioning element 326 is used for precision alignment and connection between the external system and the terminals 32 of the seat body 31. The positioning element 326 can further have a guiding angle to help positioning. The terminal seat 30 has a display 327 such as a light-emitting diode (LED), but not limited to this example. It is used to indicate the connection status between the hot swap fan 6A and the external system or the status of the hot swap fan 6A itself.

As shown in FIG. 7B, the coupling elements 33 are coupled to the connecting parts 352 so that the seat body 31 is held within the accommodating space 351 when assembling the fan with the terminal seat 30. Since the diameter of the connecting parts 352 is larger than that of the coupling elements 33, the coupling elements 33 can move in the X and/or Y direction with respect to the connecting parts 352. This increases the precision in the electrical connection between the terminal seat 30 and the external system.

Please refer to FIGS. 8A and 8B. In the third embodiment of the disclosed hot swap fan 6B, elements that are in common with fan 6A are assigned the same reference numerals, and will not be explicitly described herein, the description that follows being limited to the differences thereof. Specially, the hot swap fan 6B further includes a buckle 9 disposed in the connecting part 352. The buckle 9 has a sliding groove 91. The coupling elements 33 are disposed inside the sliding groove 91 in a slideable way. The terminal seat 30 is thereby limited to float in a single direction (e.g., Y direction) relative to the fan frame 3. Moreover, the width W′ of the seat body 31 is slightly smaller than the width W of the accommodating space 351 so that the terminal seat 30 can move in the Z direction relative to the fan frame 3.

The moving mechanism of the terminal seat 30 relative to the buckle 9 is described as follows. As shown in FIGS. 9A and 9B, the sliding groove 91 is a long circular through hole. Correspondingly, the coupling element 33 is a long circular rod. The terminal seat 30 is disposed inside the sliding groove 91 by the coupling element 33 in a slideable way. The length D of the sliding groove 91 is greater than the length d of the coupling element 33. Therefore, the seat body 31 can move in the Y direction relative to the hot swap fan 6B. Besides, the width W′ of the seat body 31 is slightly smaller than the width W of the accommodating space 351. Therefore, the seat body 31 can move in the Z direction with respect to the hot swap fan 6B at the same time. Consequently, the terminal seat 30 can move in one-dimensional or two-dimensional moving motion with respect to the fan frame 3 of the hot swap fan 6B. This ensures the precision electrical connection between the hot swap fan 6B and the external system.

In the third embodiment, the sliding groove 91 of the buckle 9 is a through hole for accommodating the coupling element 33. According to the spirit of the invention, the sliding groove 91 can be a recess as well. In this case, the coupling element 33 is disposed inside the sliding groove 91 in a slideable way.

Also, the coupling element 33 and the buckle 9 are respectively a protruding rod and a through hole or recess that match with each other. According to the spirit of the invention, the coupling element 33 can be a through hole or recess and the buckle 9 is a protruding rod as well, as long as the configuration serves the enablement of moving the terminal seat.

As shown in FIG. 10, elements that are in common with the hot swap fan 6B shown in FIG. 8A are assigned the same reference numerals, and will not be explicitly described herein, the description that follows being limited to the differences therewith. Specially, the hot swap fan 6C shown in FIG. 10 further includes a buckle 9A disposed in the connecting part 352 and a hook 328 is disposed on the terminal of coupling element 33A of the terminal seat 30A. Further referring to FIGS. 11A and 11B, the buckle 9A has a sliding groove 91A and a protrusion 911 is disposed on the inner wall of the sliding groove 91A. The coupling element 33A is disposed in the sliding groove 91A so that the terminal seat 30A is thereby limited to move in a single direction (e.g., Y direction) by the hook 328 and the protrusion 911 to be coupled with. Moreover, the width W′ of the seat body 31 is slightly smaller than the width W of the accommodating space 351 so that the terminal seat 30A can move in the Z direction relative to the fan frame 3.

The moving mechanism of the terminal seat 30A relative to the buckle 9A is similar to that of the terminal seat 30 relative to the buckle 9 and will not be explicitly described herein.

FIGS. 11A and 11B show the relationship between the terminal seat 30A and the fan frame 3. FIG. 11A is a schematic view showing the terminal seat 30A assembled to the hot swap fan and FIG. 11B is an enlarged view of a part of the FIG. 11A. In FIG. 11A, the coupling element 33A of the terminal seat 30A is disposed through the sliding groove 91A of the buckle 9A to connect with the connecting part 352 of the fan frame 3. The hook 328 is disposed on the terminal of coupling element 33A, and the protrusion 911 is disposed on the inner wall of the sliding groove 91A. As shown in FIG. 11B, by the profiles of the protrusion 911 and the hook 328, the terminal seat 30 can be ensured moving in the Z direction and the buckle 9A can be prevented to drop from the connecting part 352.

FIG. 12 is a schematic view showing the variation of the terminal seat 30A assembled to the hot swap fan shown in FIG. 11A. The difference is in that a protrusion 332A is disposed in the inner wall of the connecting part 352 of the fan frame 3. The coupling element 33A of the terminal seat 30A can be disposed through the connecting part 352 of the fan frame 3 so that the terminal seat 30A can be ensured moving in the Z direction by the protrusion 332A and hook 328 of the coupling element 33A. Since the protrusion 332A is disposed in the connecting part 352 of the fan frame 3, the terminal seat 30A can be assembled to the fan frame 3 without the buckle 9A.

In summary, the terminal is designed as above-mentioned knife-type terminal or clamping-type terminal to enlarge the electrical contact surface area of the terminal, to enhance the terminal intensity, to prevent poor contact at the terminal and to provide the predetermined level of fixing force according to the fan, the terminal seat of the fan and the method of forming the terminal seat. Because the working surface of the knife-type terminal of the invention is different from the swapping direction, the thickness of the knife-type terminal is not restricted and the intensity of the knife-type terminal is higher, and the production and assembling yields of the terminal seat can be greatly increased. In addition, because the knife-type terminal of the invention has the plate-like structure, the knife-type terminal may be embedded in the seat body when the seat body of the terminal seat is being shaped. Thus, the connection intensity between the knife-type terminal and the seat body can be greatly increased, and the production yield and the production speed can be greatly increased. Furthermore, using the structure of coupling elements and a seat body, the terminal seat of the invention can move in one-dimensional or two-dimensional motion with respect to the fan frame of the disclosed hot swap fan. In comparison with the prior art, the disclosed hot swap fan adjusts the connection position and angle of the terminal seat to match the connecting terminal of the external system. Therefore, the invention can ensure the precision electrical connection between the hot swap fan and the external system, increasing the reliability thereof.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hot swap fan comprising:
a fan frame having a corner formed with an accommodating space and two connecting parts disposed adjacent to the accommodating space; and
a terminal seat having a seat body and two coupling elements disposed on both sides of the seat body and coupled to the connecting parts correspondingly so that the seat body is disposed in the accommodating space for enabling the terminal seat to move in one-dimensional or two-dimensional motion with respect to the fan frame.

2. The hot swap fan of claim 1, wherein the coupling elements are disposed symmetrically, asymmetrically or alternately on both sides.

3. The hot swap fan of claim 1, wherein the seat body has an L-shaped cross section and the coupling elements are disposed at the turning point of the seat body.

4. The hot swap fan of claim 1, wherein the coupling element has an elliptical, circular, square, or polygonal shape.

5. The hot swap fan of claim 1, further comprising a buckle disposed on the connecting part.

6. The hot swap fan of claim 5, wherein the buckle has a sliding groove for enabling the coupling elements to move therein.

7. The hot swap fan of claim 5, wherein the coupling element is a protruding rod and the buckle is a through hole or a recess, or the coupling element is a through hole or a recess and the buckle is a protruding rod.

8. The hot swap fan of claim 6, wherein the buckle has a protrusion formed in the sliding groove and the coupling element has a hook to be coupled with the protrusion.

9. The hot swap fan of claim 8, wherein the length of the sliding groove is larger than those of the coupling elements.

10. The hot swap fan of claim 1, wherein the width of the seat body is slightly smaller than that of the accommodating space.

11. The hot swap fan of claim 1, further comprising a LED mounted on the terminal seat or the fan frame.

12. The hot swap fan of claim 1, wherein the seat body has several terminals and terminal slots.

13. The hot swap fan of claim 12, wherein the terminal is made of electrically conductive material or coated by an electrically conductive material.

14. The hot swap fan of claim 1, wherein the terminal is a knife-type terminal with a fixing portion to be mounted on the seat body.

15. The hot swap fan of claim 1, wherein the seat body comprises a positioning element with a guiding angle.

16. The hot swap fan of claim 15, wherein the positioning element is made of non-conductive material, and integrally formed with the seat body as a single unit.

17. The hot swap fan of claim 1, wherein the coupling element is integrally formed with the seat body as a single unit.

18. The how swap fan of claim 1, wherein the coupling element has a hook or an engaging member corresponding to a protrusion of the connecting part.

19. The hot swap fan of claim 1, wherein the coupling element is a through hole or a recess and the connecting part has a protrusion, or the coupling element has a protrusion and the connecting part has a through hole or recess.
